(19) United States
(12) Patent Application Publication
(10) Pub. No.: US 2016/0070367 A1
(43) Pub. Date: Mar. 10, 2016

(54) WEARABLE ELECTRONIC DEVICE AND CURSOR CONTROL DEVICE

(71) Applicant: HTC Corporation, Taoyuan County (TW)

(72) Inventor: Yi-Pang Lin, Taoyuan County (TW)

(21) Appl. No.: 14/477,886

(22) Filed: Sep. 5, 2014

(51) Int. Cl. G06F 3/038; G06F 3/03; G06F 1/16

(52) U.S. Cl. CPC G06F 3/0383; G06F 1/163; G06F 3/0308

(57) ABSTRACT

A wearable electronic device adapted to be worn on a user's wrist is provided. The wearable electronic device includes a wristband, a main body of the device, and a sensing unit. The device body is disposed on the wristband and includes a display unit and a control unit, wherein the display unit is electrically coupled to the control unit. The sensing unit is disposed on the wristband, and opposed to the device body. The sensing unit is electrically coupled to the control unit for sensing the data in relation to the outward movement, so as to perform the cursor pointing function. Furthermore, a cursor control device is also provided.

### FIELD OF THE INVENTION

The invention relates to a wearable electronic device and a cursor control device, and more particularly, the invention relates to a wearable electronic device and a cursor control device having a pointing function.

### DESCRIPTION OF RELATED ART

With the rapid development of mobile communication technology, mobile electronic devices are generally required to have quality such as high performance, light, thin, compact and readily portable, so as to comply with the consumers' demands and market development trends. Recently, mobile communication functions are further integrated into wearable devices (such as watches, eye glasses, and the like), such that the mobile communication devices may be directly wearable for a user, so as to increase convenience of use and portability.

However, in the case of the recent wearable devices like wearable intelligent watches, the dimensions thereof are unable to be flexibly adjusted according to users' actual requirements. In addition, merely a single way transmission function, such as common information recording, is used in the application of most of the recent wearable electronic devices, and still no other function can further be used in the application, for example serving as a peripheral accessory of a host computer. Moreover, as for the design of recent wearable electronic devices, the volume of the device being too large is an existing problem, and the accommodated volume and the volume of the device itself have to be minified.

### SUMMARY OF THE INVENTION

The invention provides a wearable electronic device which has a pointing function and may accommodate a wireless transceiver unit therein.

The invention provides a cursor control device which has functions of cursor display and control on a display screen.

An exemplary embodiment of the invention provides a wearable electronic device, adapted to be worn on a user's wrist. The wearable electronic device includes a wristband, a main body and a sensing unit. The main body is disposed on the wristband, and includes a display unit and a control unit, wherein the display unit is electrically coupled to the control unit. The sensing unit is also disposed on the wristband, and the sensing unit and the main body are respectively disposed on two opposite positions of the wristband. The sensing unit is electrically coupled to the control unit, used for sensing a moving information of the wearable electronic device relative to the outside, for performing a pointing function.

An exemplary embodiment of the invention provides a cursor control device, adapted to be worn on a user's wrist. The cursor control device includes a wristband, a main body and a sensing unit. The main body is disposed on the wristband, and includes a display unit and a control unit, wherein the display unit is electrically coupled to the control unit. The sensing unit is disposed on the wristband, and the sensing unit is electrically coupled to the control unit, used for sensing a moving information of the cursor control device relative to the outside, for performing a cursor control function. The display unit has a first display mode and a second display mode. When the cursor control device is mounted on the user's wrist, the display unit displays the first display mode, and when the cursor control device performs the cursor control function, the display unit displays the second display mode.

In light of the above, in the abovementioned embodiments of the invention, the wristband of the wearable electronic device is bendable and deformable, adapted to be worn on different users' wrists with different dimensions. In addition, the wearable electronic device has pointing function and thus may serve as a cursor control device, wherein the optical signal detected by the sensing unit may be transmitted to the operating machine through the wireless transceiver unit, so that the relative cursor movement is displayed on the display device. Furthermore, through the pivoting elements like hinges and the accommodating portion disposed on the wristband, the wearable electronic device of the invention may accommodate the wireless transceiver unit on the wristband, and further through the folding via the pivoting elements, the body of the wearable electronic device may be minimized and convenient to be gathered up.

To make the above features and advantages of the invention more comprehensible, several embodiments accompanied with drawings are described in detail as follows.

### BRIEF DESCRIPTION OF THE DRAWINGS

FIG. 1 is a perspective schematic view of a wearable electronic device according to an exemplary embodiment of the invention.

FIG. 2 is a perspective side view of the wearable electronic device of FIG. 1.

FIG. 3 is a perspective schematic view of a wearable electronic device according to another exemplary embodiment of the invention.

FIG. 4 is a perspective schematic view of the wearable electronic device of FIG. 3 according to another embodiment.

FIG. 5 is a partial top view schematically showing the wearable electronic device of FIG. 1.

### DESCRIPTION OF THE EMBODIMENTS

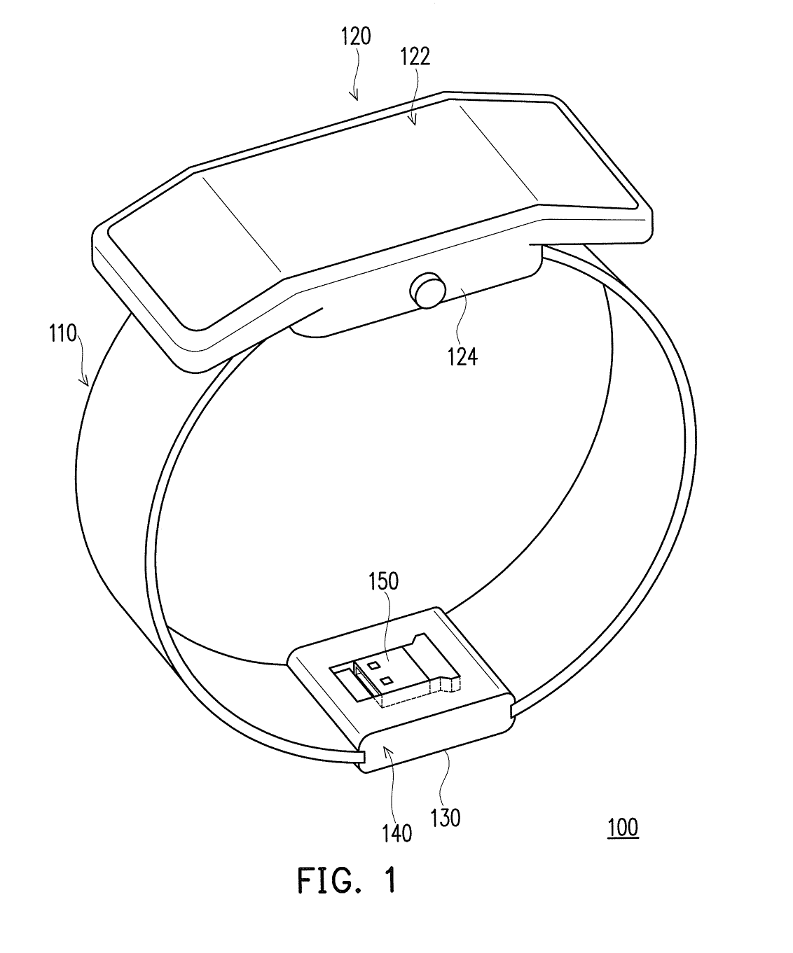

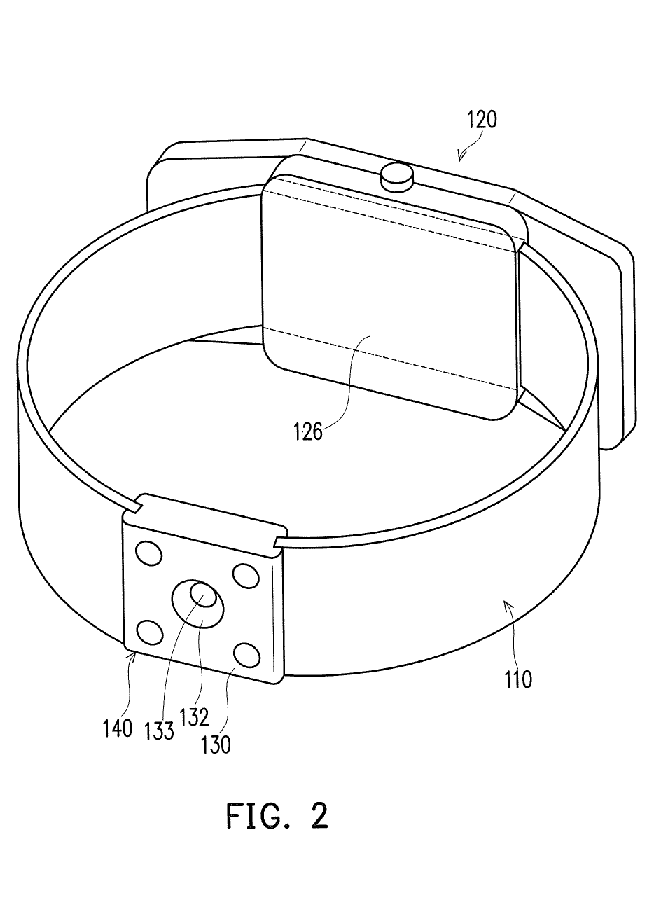

FIG. 1 is a perspective schematic view of a wearable electronic device according to an exemplary embodiment of the invention, and FIG. 2 is a perspective side view of the wearable electronic device of FIG. 1. Referring to FIG. 1, the wearable electronic device 100 includes a wristband (or a watch band) 110, a main body 120 and a sensing unit 130. The main body 120 is disposed on the wristband 110, and includes a display unit 122 and a control unit 124, wherein the display unit 122 is electrically coupled to the control unit 124. In addition, the sensing unit 130 is disposed on the wristband 110. In this embodiment, the main body 120 and the sensing unit 130 are respectively located at two opposite positions on the wristband 110, but the invention is not limited thereto, and the main body 120 and the sensing unit 130 may also be disposed on other positions of the wristband 110 suitably as required. In addition, the sensing unit 130 is electrically coupled to the control unit 124, used for sensing a moving information of the wearable electronic device 100 relative to a working plane, for performing a pointing function, wherein the moving information includes a displacement vector of the wearable electronic device 100 relative to the working plane (not shown) of the user, namely the distance, velocity and direction as the wearable electronic device 100 is moving on the working plane. In the embodiment, the wearable electronic device 100 may telecommunicate to an operating device such as a host computer, and the operating device may further be electrically coupled to a display screen, so as to display a cursor corresponding to the displacement vector of the wearable electronic device 100 on a display screen. Therefore, the user may use the wearable electronic device 100 to control the movement of the cursor on the display screen.

Accordingly, the user may wear the wearable electronic device 100 through the wristband 110 on the position of wrist, so as to conveniently use and take along, and alternatively the wearable electronic device 100 may serve as a wireless mouse device, for co-operating with the host computer to control the cursor movement on the display screen. On the other hand, referring to FIG. 2, in the embodiment, one side of the main body 120 opposite to the display unit 122 may has a position limiting slot 126, used for disposing a portion of the wristband 110 therein and movably connecting the main body 120 and the wristband 110, so that the user may adjust the relative position of the main body 120 on the wristband 110 according to one's own habit. However, the connecting way of the main body 120 and the wristband 110 is not limited to the embodiment, and engaging elements for engaging or directly adhering method may also be used for the connection therebetween in the disclosure, for example.

On the other hand, the sensing unit 130 disposed opposite to the main body 120 on the wristband 110 may be optical sensing component of a laser sensor, for example, and the optical sensing component includes a light emitter 133 and a light receiver 132. The sensing unit 130 uses the light emitter 133 to emit a light to the surface of the platform that the wearable electronic device 100 moves thereon, and the light reflected from the surface is captured by the light receiver 132, so as to obtain the moving information of the movement of the sensing unit 130 relative to the platform surface. In addition, as mentioned above, the sensing unit 130 may transmit the detected information to the operating device such as a host computer, and the cursor on the display screen of the host computer may display the relative movement of the device itself (for example, moving direction, distance, velocity, and the like). Therefore, in the embodiment, the wearable electronic device 100 may serve as a cursor control device such as a mouse.

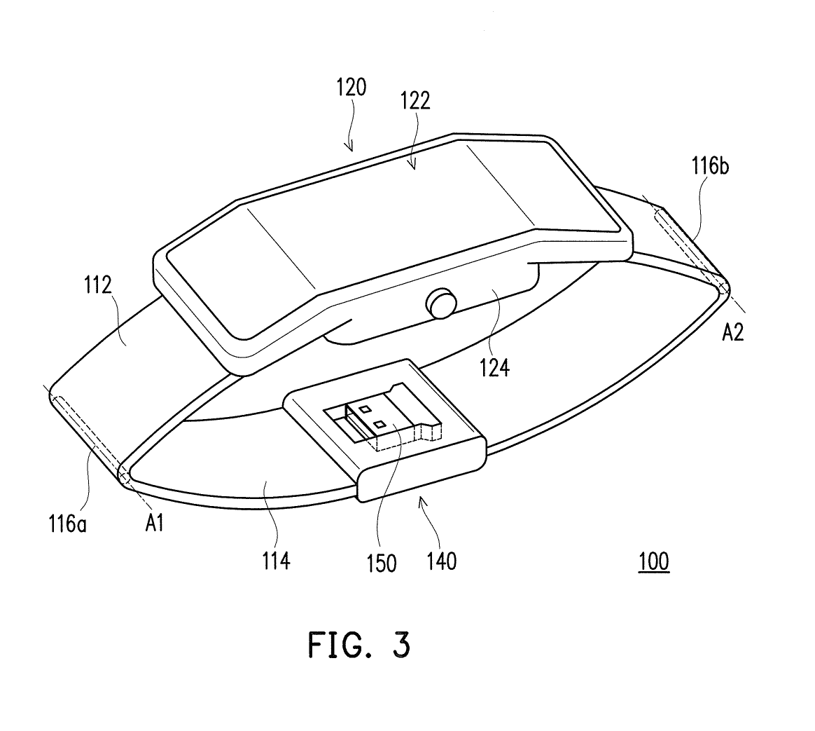

Furthermore, the wearable electronic device 100 may further include a mode switching element (not shown) disposed on the pivoting shaft A1 or A2 (shown in FIG. 3). When the pivoting shaft A1 or A2 rotates to a predetermined position, the mode switching element is triggered, and such that the display unit 122 may switch between the first display mode and the second display mode. In the embodiment, the first display mode is a normal control mode and may display time, weather or other information. In addition, the second display mode is a cursor control mode, and in the cursor control mode, the sensing unit 130 is activated to perform the cursor control function. When the wearable electronic device 100 which also serves as a cursor control device is worn on the user's wrist, the display unit 122 may be the first display mode. On the other hand, when the wearable electronic device 100 which also serves as a cursor control device is used for performing the cursor control function, the display unit 122 may be the second display mode.

In the embodiment, the wristband 110 may be composed of rubber, silicone, elastic piece or any other flexible materials which are bendable or resilient. Since the wristband 110 is bendable or deformable, the dimension of the wristband 110 may be suitably flexibly adjusted according to the dimension of the user's wrist, so that the wearable electronic device 100 of the embodiment may meet the demands of sizes for most users to wear with a single dimension or less fixed dimension, co-operating with the flexibly stretchable wristband 110.

FIG. 3 is a schematic view of a wearable electronic device 100 according to another exemplary embodiment of the invention. Referring to FIG. 3, the wristband 110 may include a first portion 112 connected to the main body 120, and a second portion 114 connected to the sensing unit 130. In addition, in the embodiment, a pair of pivoting elements 116a, 116b, e.g., hinges, are respectively connected to the two ends of the first portion 112 and the second portion 114. Since the wristband 110 may be a flexible, bendable and band-like structure, after the wristband 110 is bent or deformed, the display unit 122 changes the first display mode into the second display mode. In addition, when the wearable electronic device 100 is used as a cursor control device, according to the height where the user holding the wearable electronic device 100, the wristband 110 may be suitably bent via the pivoting elements 116a and 116b, so as to fit with the using condition of the user. Furthermore, the two ends of the first portion 112 and the second portion 114 of the wristband 110 are respectively pivoted via the pivoting shafts A1 and A1 of the pivoting elements 116a and 116b, and respectively rotate and bend in a small radius relative to the pivoting shafts A1 and A2.

Referring to FIG. 3, the preferable disposing method of the wristband 110 is that the pivoting elements 116a and 116b which respectively connect the two ends of the first portion 112 and the second portion 114 are disposed at equal or similar heights, so that as one of the user's hands applies force to press downward the wristband 110 during a using procedure, the two sides of the wristband 110 may be pressed and bent to be in equal parallel heights, so that the main body 120 disposed on the wristband 110 may not incline to left or right, so as to increase the controllability in the cursor operating mode. In addition, when the wearable electronic device 100 is not in use, the wearable electronic device 100 may be folded along the pivoting elements 116a and 116b of the two ends for stored, so as to save the stored volume of the wearable electronic device 100. In the embodiment, the wristband 110 with the two ends having the pivoting elements 116a and 116b is exemplarily illustrated, but the invention is not limited thereto, other wristbands or watch bands with suitable materials or design may also be applied in the wearable electronic device 100 of the embodiment.

In another embodiment which is not shown in the drawings, the wristband 110 may also be provided with a flexible circuit board (not shown), so as to electrically connect the control unit 124 and the sensing unit 130, such that the optical sensing signal or information of the sensing unit 130 may be transmitted to the control unit 124 via the flexible circuit board, and is directly displayed on the display unit 122, and also used as other types of optical sensing application such as infrared thermal sensing. In addition, the wristband 110 may also include a flexible display device, for example, organic light emitting diode (OLED) panel, so that the wristband 110 may further display various image information.

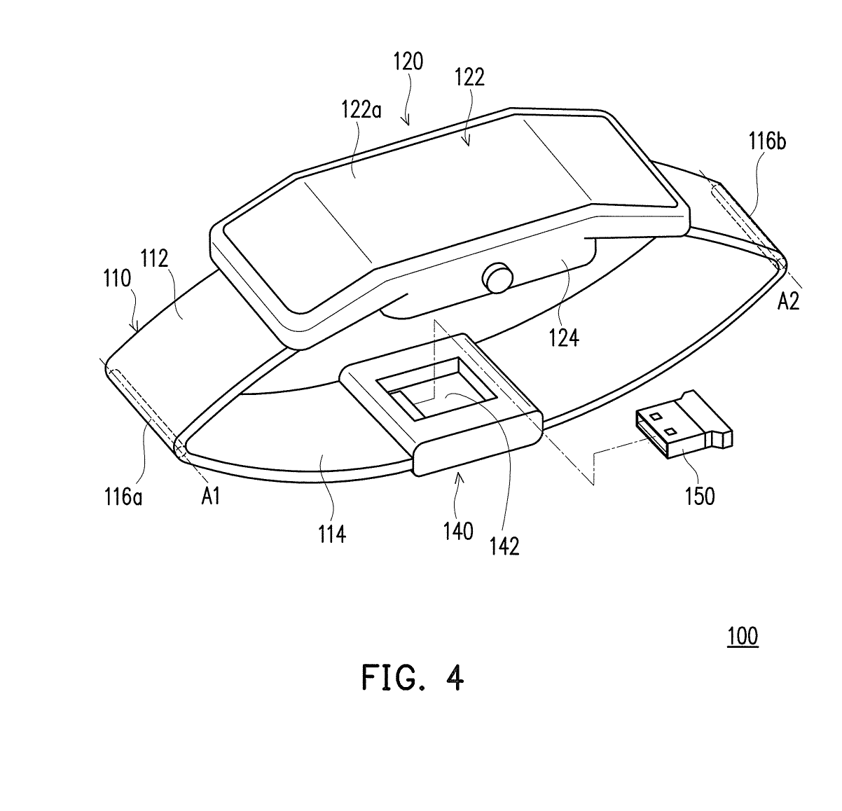

FIG. 4 is a schematic view of the wearable electronic device of FIG. 3 according to another embodiment. The wristband 110 includes an accommodating portion 140, and the accommodating portion 140 may be used for accommodating the wireless transceiver unit 150 therein. The accommodating portion 140 may have an accommodating slot 142, and the shape of the accommodating slot 142 may be an inserting slot having a USB connector, for example. The wireless transceiver unit 150 may be electrically connected to the main body 120 and the sensing unit 130 via the accommodating slot 142, so that the touch signal of the main body 120 or the optical sensing signal of the sensing unit 130 may be transmitted to the wireless transceiver unit 150, and then via the wireless transceiver unit 150 the telecommunication signal is transmitted to the connecting interface (not shown) of the host computer via the wireless transceiver unit 150. In addition, the sensing unit 130 may also be disposed at a side, which is the same as or opposite to the wireless transceiver unit 150 of the accommodating portion 140, so as to avoid from repeatedly disposing unnecessary accommodating space, and the volume of the entire wearable electronic device 100 may further be reduced, so that the design of the entire wearable electronic device 100 is light and thin.

Referring again to FIG. 4, in the embodiment, the wireless transceiver unit 150 may be a wireless blue-tooth receiver, for example. The optical sensing signal of the sensing unit 130 is transmitted to the host computer or the connecting interface (not shown) of other electronic devices through the wireless blue-tooth receiver, so as to define a mouse cursor position on the display screen of the computer or other electronic devices. In addition, the wireless transceiver unit 150 may also receive the touch signal on the main body 120 through the flexible circuit board disposed on the wristband 110 of the abovementioned embodiment and transmit the touch signal to the host computer, so as to control the cursor motion (e.g., distance and position) on the computer display screen or display the up-down scroll of the window scroll. Although the wireless blue-tooth receiver is exemplarily illustrated in the embodiment for the technique of wireless communication between the wearable electronic device 100, the sensing unit 130, the host computer and its display screen, the invention is not limited thereto, and any other near field communication (NFC) modules may also be provided to the wearable electronic device 100 by suitably designing and adjusting, for the wireless signal transmission between the host computer and the wearable electronic device 100.

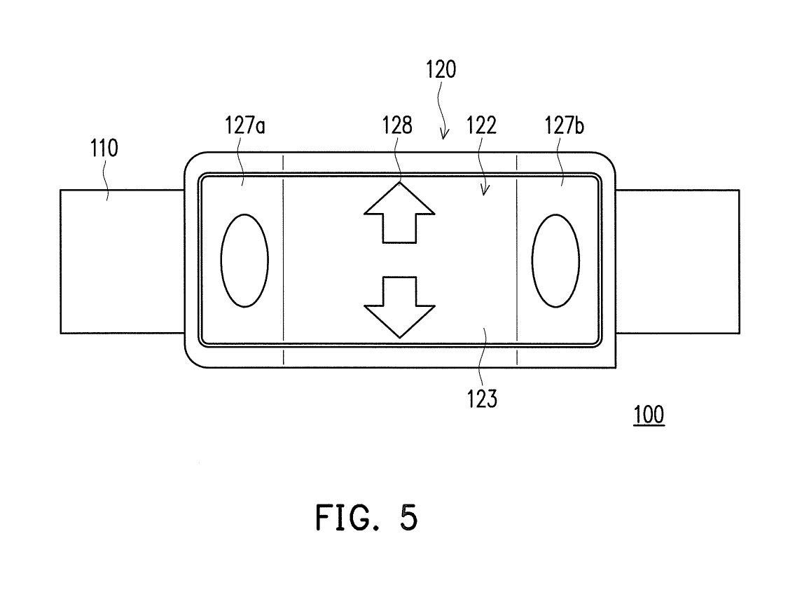

FIG. 5 is a partial top view schematically showing the wearable electronic device of FIG. 1. Herein the display unit 122 of the main body 120 includes a touch input element 123. The touch input element 123 may display information such as time, date, and the like, may also display various touch interactive software application programs, but the invention is not limited thereto, the sensing results of other various physiological signals, such as blood pressure, breathing, heart beating, and the like, of a monitoring application apparatus electrically coupled to the wearable electronic device 100, may also be displayed on the touch input element 123. In addition, in the embodiment, the touch input element 123 may provide a mouse operating interface, and makes the display unit 122 change into the second display mode, so that the wearable electronic device 100 of the embodiment becomes a cursor control device. The mouse operating interface of the touch input element 123 has key areas 127a and 127b at the left and right sides similar to actual mouse click keys, and a scroll area 128 which may simulate the actual mouse scroll function to control the computer window scroll and image to up and down. Moreover, the touch input element 123 of the invention may have a curved surface touch screen as shown in FIG. 1 or FIG. 3, the wearable electronic device 100 is used as a cursor control device, the curved surface touch screen may let the wearable electronic device 100 have an arc-shaped curved surface which is similar to actual mouse device, so that the user's hand may more suitably attach on the touch input element 123 when the user uses the mouse operating interface, and thus the user may control the cursor on the computer display screen in a more ergonomic way.

In light of the foregoing, the invention discloses a wearable electronic device, such as an intelligent watch, having a pointing function. The wearable electronic device has a bendable and deformable wristband, thus the dimension of the wristband may be suitably flexibly adjusted according to the dimension of the user's wrist, so that the wearable electronic device may be provided with a single dimension or less fixed dimension to meet the demands of sizes for most users to wear, the manufacturing process of the wearable electronic device may be simplified, and the manufacturing material and cost may also be reduced. Furthermore, the wristband has a pair of pivoting elements, such as hinges, which are symmetrically disposed at the two ends of the wristband, so that the wearable electronic device may be used as a cursor control device, and when the user's hand applies force to press downward, the wristband may be bent in a small radius along the pivoting elements, such that the two ends of the main body of the wearable electronic device may be maintained at a symmetric and balanced height. Additionally, the wristband of the invention includes an accommodating portion which includes an accommodating slot, used for accommodating the wireless transceiver unit within the wristband. Moreover, the sensing unit may also be disposed on the accommodating portion, so as to further reduce the entire volume of the wearable electronic device, to achieve a light and thin design.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A wearable electronic device, adapted to be worn on a user's wrist, comprising:
a wristband;
a main body, disposed on the wristband, and comprising a display unit and a control unit, wherein the display unit is electrically coupled to the control unit; and
a sensing unit, disposed on the wristband, and the sensing unit electrically coupled to the control unit, used for sensing a moving information of the wearable electronic device relative to a plane, so as to perform a pointing function, wherein the moving information comprises a displacement vector of the wearable electronic device relative to the plane, used for serving as a moving basis of a cursor on a computer screen.

2. The wearable electronic device as claimed in claim 1, wherein the wristband is bendable or deformable.

3. The wearable electronic device as claimed in claim 1, further comprising a mode switching element, wherein the mode switching element is electrically coupled to the control unit, when the mode switching element is triggered, a display information of the display unit is switched.

4. The wearable electronic device as claimed in claim 3, further comprising at least one pivoting shaft disposed on the wristband, wherein the mode switching element is disposed on the at least one pivoting shaft, when the at least one pivoting shaft rotates to a predetermined position, the mode switching element is triggered.

5. The wearable electronic device as claimed in claim 1, wherein the wristband comprises:
a first portion, connected to the main body;
a second portion, connected to the sensing unit; and
a pair of pivoting elements, respectively pivoting two ends of the first portion and the second portion along a pivoting shaft, wherein the two ends of the first portion and the second portion respectively rotate along the pivoting shaft.

6. The wearable electronic device as claimed in claim 1, further comprising a wireless transceiver unit, the wireless transceiver unit adapted to match up with a connecting interface of an electronic device, wherein the control unit is electrically coupled to the electronic device in a wireless manner via the wireless transceiver unit.

7. The wearable electronic device as claimed in claim 6, wherein the wristband has an accommodating portion, located at a position of the wristband relatively away from the main body, and the accommodating portion has an accommodating recess, used for accommodating the wireless transceiver unit.

8. The wearable electronic device as claimed in claim 1, wherein the sensing unit comprises a light emitter and a light receiver, through the light emitter emitting a light to an outside surface for generating a reflected light, the light receiver receives the reflected light, so as to obtain a moving information of the sensing unit relative to the surface.

9. A cursor control device, adapted to be worn on a user's wrist, comprising:
a wristband;
a main body, disposed on the wristband, and comprising a display unit and a control unit, wherein the display unit is electrically coupled to the control unit; and
a sensing unit, disposed on the wristband, the sensing unit electrically coupled to the control unit, used for sensing a moving information of the cursor control device relative to an outside, for performing a cursor control function, and the display unit having a first display mode and a second display mode, wherein when the cursor control device is mounted on the user's wrist, the display unit displays the first display mode, and when the cursor control device performs the cursor control function, the display unit displays the second display mode.

10. The cursor control device as claimed in claim 9, wherein the wristband is bendable or deformable, and after the wristband is bent or deformed, the display unit transforms the first display mode to the second display mode.

11. The cursor control device as claimed in claim 10, wherein the cursor control device further comprises a mode switching element, wherein the mode switching element is electrically coupled to the control unit, when the wristband is bent or deformed, the cursor control device is switched from the first display mode into the second displayed mode by the mode switching element.
